(19) United States
(12) Patent Application Publication
(10) Pub. No.: US 2026/0302058 A1
(43) Pub. Date: Oct. 1, 2026

(54) TRANSFORMER AND ELECTRICAL DEVICE WITH TRANSFORMER

(71) Applicant: TDK Electronics AG, Muenchen (DE)

(72) Inventor: Samir EL AJLAOUI, Muenchen (DE)

(21) Appl. No.: 19/475,388

(22) PCT Filed: Mar. 25, 2024
(86) PCT No.: PCT/EP2024/057942

§ 371 Date: Oct. 14, 2025

(30) Foreign Application Priority Data
Apr. 19, 2023 (DE) 102023109895.0

(51) Int. Cl. H01F 38/08; H01F 3/14; H01F 27/00; H01F 27/28; H02M 3/00; H02M 3/22

(52) U.S. Cl. CPC H01F 38/08; H01F 3/14; H01F 27/006; H01F 27/2823; H02M 3/01; H02M 3/22

(57) ABSTRACT

In an embodiment a transformer includes a first secondary coil unit, a primary coil and a second secondary coil unit arranged in succession along an axial direction, and a magnetic core including a central core portion, which is located in the primary coil, the first secondary coil unit and the second secondary coil unit so that the primary coil, the first secondary coil unit and the second secondary coil unit each surround the central core portion in a radial direction, wherein the primary coil is arranged between the first secondary coil unit and the second secondary coil unit, and wherein a first coil gap defining a first coil distance along the axial direction is provided between the primary coil and the first secondary coil unit and a second coil gap defining a second coil distance along the axial direction is provided between the primary coil and the second secondary coil unit.

### CROSS-REFERENCE TO RELATED APPLICATIONS

This patent application is a national phase filing under section 371 of PCT/EP2024/057942, filed Mar. 25, 2024, which claims the priority of German patent application no. 102023109895.0, filed Apr. 19, 2023, each of which is incorporated herein by reference in its entirety.

### TECHNICAL FIELD

A transformer and an electrical device with a transformer are specified.

### BACKGROUND

So-called LLC converters are widely used as DC-DC converters in various applications, for example in connection with chargers for electric vehicles, as they can have a high-power density and a high efficiency and at the same time can be cost-efficient. Typically, in a charger application, an LLC converter is connected to a DC source such as a rectifier, a DC link or a battery and is used to generate a DC current required for a battery connected on the output side. An LLC converter usually has a transformer between an inverter and a rectifier, which is connected in series with an additional inductance and a capacitor in LLC topologies. It can be advantageous here if the leakage inductance of the transformer is used as the additional inductance instead of an additional component. For this purpose, however, the transformer must be designed with a high leakage inductance. The requirement for high leakage inductance values can be met by a two-chamber winding in which the primary windings and the secondary windings are located in two different chambers separated by a partition. Stranded wires can be used here to reduce additional losses. However, a further reduction of the additional losses is difficult if a high leakage inductance is to be achieved at the same time.

### SUMMARY

Embodiments provide a transformer. Further embodiments provide an electrical device with a transformer.

According to at least one embodiment, a transformer comprises a primary coil, a first secondary coil unit and a second secondary coil unit.

According to at least one further embodiment, an electrical device comprises such a transformer.

The features and embodiments described below apply equally to the transformer and to the electrical device.

According to a further embodiment, the transformer has a three-chamber structure, also known as a three-chamber winding. Although losses can be reduced with a three-chamber winding compared to a two-chamber winding, the leakage inductance is usually also reduced, which appears counterproductive with regard to the above-mentioned avoidance of additional inductance in series to the transformer. Although increasing the number of windings could increase the leakage inductance, this would also increase the main inductance. However, it has been shown that a transformer with the desired properties can be achieved using the features and embodiments described below.

According to a further embodiment, the first secondary coil unit, the primary coil and the second secondary coil unit are arranged in succession along an axial direction. The axial direction may in particular be defined by a winding axis around which the windings of the primary coil, the first secondary coil unit and the second secondary coil unit are wound. The first secondary coil unit, the primary coil and the second secondary coil unit can, for example, have a round winding cross-section, such as a circular winding cross-section, or a polygonal winding cross-section, such as a square or hexagonal winding cross-section, with the winding cross-section being perpendicular to the axial direction. Directions perpendicular to the axial direction are referred to as radial directions.

According to a further embodiment, the primary coil is arranged between the first secondary coil unit and the second secondary coil unit. The first secondary coil unit and the second secondary coil unit can thus be arranged opposite one another as viewed in the axial direction from the primary coil. Preferably, the first and second secondary coil units can be connected in series and thus together form a secondary coil. The series connection can, for example, be formed in the transformer itself, so that exactly two connections can be provided on the transformer for external contacting of the secondary coil. Alternatively, each of the first and second secondary coil units can have two connections for external contacting, so that the series connection can be achieved, for example, by an external connection of a connection of the first secondary coil unit and a connection of the second secondary coil unit.

Each of the primary coil, the first secondary coil unit and the second secondary coil unit can, for example, be arranged in a chamber of a coil carrier, resulting in the three-chamber structure. A first coil gap, which defines a first coil distance, is present along the axial direction between the primary coil and the first secondary coil unit. Between the primary coil and the second secondary coil unit, there is a second coil gap along the axial direction, which defines a second coil gap. In other words, the first secondary coil unit and the second secondary coil unit are each spaced apart from the primary coil. For example, a first partition wall may be arranged between the primary coil and the first secondary coil unit, and a second partition wall may be arranged between the primary coil and the second secondary coil unit, which are each part of a coil carrier. The partition walls can each have a partition wall thickness, which can have the size of the first and second coil gaps and thus determine the first and second coil gaps. Particularly preferably, the first coil gap and the second coil gap can be the same.

According to a further embodiment, the transformer has a magnetic core. The magnetic core can preferably be formed in multiple-part-fashion, i.e., have multiple parts made of a ferromagnetic material. Some or all of the multiple parts can be firmly connected to each other in the transformer, for example by adhesive connection or another material connection. In particular, the magnetic core has a central core portion, which can be formed from one or preferably several parts. The central core portion is inserted into the primary coil, the first secondary coil unit and the second secondary coil unit, so that the primary coil, the first secondary coil unit and the second secondary coil unit each surround a part of the central core portion in the radial direction. The central core portion may have a central gap arranged along the axial direction between a first gap and a second gap. In other words, the central core portion may have three gaps arranged one above the other along the axial direction. The gaps, i.e., the central gap as well as the first gap and the second gap, can particularly preferably separate four parts, formed from a ferromagnetic material, of the magnetic core and in particular of the central core portion from one another in the axial direction.

The central gap is particularly preferably arranged symmetrically to the primary coil in the axial direction. The primary coil can thus extend in the axial direction and have a height in the axial direction, with the central gap, in particular a center of the central gap, being arranged along the axial direction at half the height of the primary coil. Furthermore, the first gap and the second gap can be arranged symmetrically to the central gap along the axial direction. In other words, the first and second gaps can be equidistant from the central gap along the axial direction.

The central gap, the first gap and the second gap are particularly preferably filled with a non-ferromagnetic material which comprises or is made of, for example, air, a plastic and/or a ceramic material. For example, the central gap can be filled with air. The first and second gaps can be filled with a non-ferromagnetic material, for example a plastic and/or a ceramic material or made of such a material. The material filling the first and second gap can in particular permanently connect two parts of the central core portion to each other. Thus, the magnetic core can, for example, be formed from two units, each of which has two parts of the central core portion. The two units can be inserted from opposite sides in the axial direction into the primary coil and the first or second secondary coil unit with the respective part of the central core portion, whereby the central gap is formed after complete insertion.

According to a further embodiment, the first gap and the first coil gap have an identical first position in the axial direction and the second gap and the second coil gap have an identical second position in the axial direction, so that the first gap is surrounded in the radial direction by the first coil gap and the second gap is surrounded in the radial direction by the second coil gap.

According to a further embodiment, the first gap has a first gap width, and the second gap has a second gap width. The central gap can have a third gap width. The gap widths, i.e., the sizes of the gaps, are measured in the axial direction. The first gap and the second gap are preferably the same size. The first gap width and the second gap width can therefore preferably be the same size. The central gap is preferably larger than the first gap and larger than the second gap, so that the third gap width can correspondingly be larger than the first gap width and larger than the second gap width.

Preferably, the first coil distance can be greater than or equal to the first gap width and the second coil distance can be greater than or equal to the second gap width. Particularly preferably, the first coil distance can be greater than the first gap width and the second coil distance can be greater than the second gap width. If, as described above, there is a respective partition wall between the primary coil and each of the first and second secondary coil units, this can mean in particular that the partition walls each have a partition wall thickness, measured in the axial direction, which is at least equal to and preferably greater than the respective adjacent gap width in the radial direction. A ratio of the first coil distance to the first gap width can therefore be greater than or equal to 1 and a ratio of the second coil distance to the second gap width can also be greater than or equal to 1. Particularly preferred are the two ratios each greater than or equal to 1.1 or greater than or equal to 1.5 or greater than or equal to 2.

The primary coil can have a winding number N1. The first secondary coil unit and the second secondary coil unit preferably have the same structure and can in particular have the same number of windings N2. N1>N2 is particularly preferable. Preferably 1.3≤N1/N2≤4 can apply. N1 can, for example, be greater than or equal to 12 and less than or equal to 20 or less than or equal to 25 or less than or equal to 30. N2 can, for example, be greater than or equal to 6 and less than or equal to 10.

The three-chamber design of the transformer described here allows losses to be reduced compared to conventional two-chamber solutions and a high leakage inductance to be achieved at the same time. This can be achieved in particular by the described combination of the three-chamber structure with a targeted arrangement and formation of the gaps and coil gaps. Compared to a two-chamber structure with a primary coil and a secondary coil with the same number of windings, the number of windings of the primary coil is increased in the transformer described here, while the number of windings of the secondary coil units is reduced. The higher main inductance due to the increase in the number of windings of the primary coil can be compensated for by the so-called distributed gap formed by the central gap, the first gap and the second gap. Furthermore, as described above, the coil gaps and thus the partition walls between the primary coil and the first and second secondary coil units are arranged exactly above the first and second gaps and the partition wall thicknesses and thus the coil gaps are at least as large and preferably larger than the gap widths of the first and second gaps. Large partition wall thicknesses have the advantage that the windings of the coils are further away from the magnetic field emerging into the gaps, which can reduce additional losses. The windings are also removed from the stray field that does not contribute to the main inductance, which can lead to a further reduction in additional losses.

According to a further embodiment, the transformer is part of a resonant element of an electrical device. The resonant element can be particularly preferably connected to an inverter unit on the input side and a rectifier unit on the output side. The resonant element can also be referred to as a “resonant tank”. The electrical device, which can be configured as a DC-DC converter, for example, can thus have the resonant element between the inverter unit and the rectifier unit. The transformer can preferably form the resonant element together with at least one capacitor or exactly one capacitor. In particular, the resonance element can be free of further induction components apart from the transformer. Accordingly, apart from the transformer, no further induction component such as a coil or choke can be present between the output of the inverter element and the input of the rectifier element, but only one or more capacitors and/or one or more resistors.

### BRIEF DESCRIPTION OF THE DRAWINGS

Further advantages, advantageous embodiments and further developments become apparent from the embodiments described below in conjunction with the figures.

FIG. 1 shows a schematic illustration of a transformer according to an embodiment;

FIGS. 2A and 2B show schematic illustrations of a transformer according to a further embodiment;

FIGS. 3A and 3B show results of a simulation of the field distribution in a transformer according to a further embodiment;

FIG. 4 shows the results of a simulation of the field distribution in a transformer according to a comparative example; and FIG. 5 shows a schematic illustration of an electrical device with a transformer according to a further embodiment.

In the embodiments and figures, identical, similar or similarly acting elements can each be provided with the same reference symbols. The elements shown and their relative sizes are not to be regarded as true to scale; rather, individual elements, such as layers, components, structural elements and areas, may be shown in exaggerated size for better visualization and/or better understanding.

### DETAILED DESCRIPTION OF ILLUSTRATIVE EMBODIMENTS

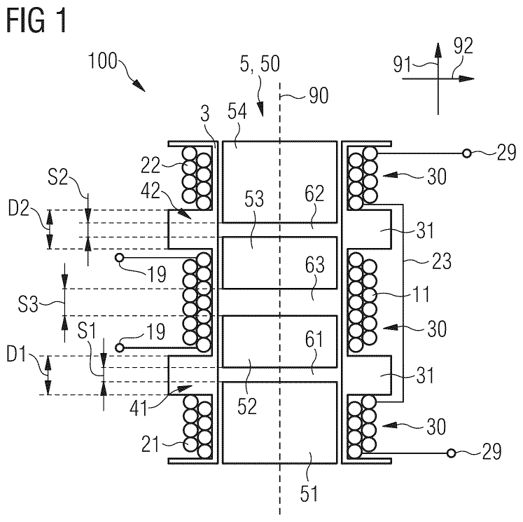

FIG. 1 shows an embodiment of a transformer 100. The transformer 100 has a three-chamber structure with a primary coil 11 and a secondary coil divided into a first secondary coil unit 21 and a second secondary coil unit 22, which are arranged in succession along an axial direction 91. The axial direction 91 is defined by the winding axis 90, indicated by a dashed line, around which the windings of the primary coil 11, the first secondary coil unit 21 and the second secondary coil unit 22 are wound. Directions perpendicular to the axial direction 91 are referred to as radial direction 92.

In the embodiment shown, the first secondary coil unit 21, the primary coil 11 and the second secondary coil unit 22 are arranged on a coil carrier 3 and can, for example, have a round winding cross-section, such as a circular winding cross-section, or a polygonal winding cross-section, such as a square or hexagonal winding cross-section, with the winding cross-section being perpendicular to the axial direction 91. Each of the primary coil 11, the first secondary coil unit 21 and the second secondary coil unit 22 is arranged in a chamber 30 of the coil carrier 3.

The primary coil 11 is arranged along the axial direction 91 between the first secondary coil unit 21 and the second secondary coil unit 22, so that the first secondary coil unit 21 and the second secondary coil unit 22 are arranged opposite each other as viewed in the axial direction 91 from the primary coil 11. As indicated in FIG. 1, the first and second secondary coil units 21, 22 can be connected in series by means of a suitable internal connection and thus form the secondary coil. Two terminals 29 are provided on the transformer for external contacting of the secondary coil. The primary coil 11 can be contacted externally via terminals 19.

A first coil gap 41, which defines a first coil distance D1, is present along the axial direction 91 between the primary coil 11 and the first secondary coil unit 21. A second coil gap 42, which defines a second coil distance D2, is present along the axial direction 91 between the primary coil 11 and the second secondary coil unit 22. In the embodiment shown, the first coil gap 41 is defined by a first partition wall 31 of the coil carrier 3 and the second coil gap 42 is defined by a second partition wall 32 of the coil carrier 3. The partition walls 31, 32 each have a partition wall thickness along the axial direction, which determines the size of the first and second coil gaps 41, 42 and thus the first and second coil distance D1, D2. Particularly preferably, the first coil distance D1 and the second coil distance D2 can be the same. Furthermore, the first secondary coil unit 21 and the second secondary coil unit 22 can preferably have the same number of windings. Thus, the first and second secondary coil units 21, 22 can be arranged and formed symmetrically with respect to the primary coil 11.

The primary coil 11 has a number of windings N1, while the first secondary coil unit 21 and the second secondary coil unit 22 each have a number of windings N2. The arrangement of the windings shown is purely exemplary. N1>N2 is particularly preferred. Preferably, 1.3≤N1/N2≤4 can apply. N1 can, for example, be greater than or equal to 12 and less than or equal to 20. N2 can, for example, be greater than or equal to 6 and less than or equal to 10. For example, as indicated in FIG. 1, N1 can be equal to 13 and N2 can be equal to 8.

Furthermore, the transformer 100 has a magnetic core 5, which is inserted into the coil carrier 3. The magnetic core 5 can preferably be formed in multiple-parts-fashion, i.e. have multiple parts 51, 52, 53, 54 made of a ferromagnetic material. Some or all of the multiple parts 51, 52, 53, 54 can be firmly connected to each other in the transformer 100, for example by an adhesive connection or another material connection. In particular, the magnetic core 5 has a central core portion 50 for this purpose or, as in the embodiment shown, is formed by the central core portion 50, which is correspondingly formed from the multiple parts 51, 52, 53, 54. The central core portion 50 is inserted into the primary coil 11, the first secondary coil unit 21 and the second secondary coil unit 22, so that the primary coil 11, the first secondary coil unit 21 and the second secondary coil unit 22 each surround the central core portion 50 in the radial direction 92.

The central core portion 50 has three successive gaps 61, 62, 63 along the axial direction 91. In particular, the central core portion 50 has a first gap 61, a second gap 62 and a central gap 63, so that the magnetic core 5 is a core with a distributed gap. The central gap 63 is arranged, along the axial direction 91, between the first gap 61 and the second gap 62. The gaps 61, 62, 63 separate the four parts 51, 52, 53, 54 of the magnetic core 5 and in particular of the central core portion 50.

As shown, the central gap 53 is arranged symmetrically to the primary coil 11 in the axial direction 91. The primary coil 11 has a height in the axial direction 91 and the central gap 63, in particular a center of the central gap 63 along the axial direction 91, is arranged at half the height of the primary coil 11. Furthermore, the first gap 61 and the second gap 62 are arranged symmetrically to the central gap 63 along the axial direction 91, so that the first and second gaps 61, 62 are equidistant from the central gap 63 along the axial direction 91.

The first gap 61, the second gap 62 and the central gap 63 are particularly preferably filled with a non-ferromagnetic material, for example selected from air, a plastic and a ceramic material.

The first gap 61 and the first coil gap 41 have the same first position in the axial direction 91. The second gap 62 and the second coil gap 42 have the same second position in the axial direction 91, so that the first gap 61 is surrounded in the radial direction 92 by the first coil gap 41 and the second gap 62 is surrounded in the radial direction 92 by the second coil gap 42. Accordingly, the first partition wall 31 covers the first gap 61 and the second partition wall 32 covers the second gap 62.

The first gap 61 has a first gap width S1 and the second gap 62 has a second gap width S2. The central gap 63 has a third gap width S3, wherein the gap widths S1, S2, S3 are measured in the axial direction 91. The first and second gaps 61, 62 and thus the first gap width S1 and the second gap width S2 are preferably the same size. The central gap 63 is preferably larger than the first gap 61 and larger than the second gap 62, so that the third gap width S3 is correspondingly larger than the first gap width S1 and larger than the second gap width S2. For example, the central gap 63 may have a third gap width S3 which is greater than or equal to 0.5 mm and less than or equal to 2 mm.

Preferably, the first coil distance Di is greater than or equal to the first gap width S1 and the second coil distance D2 is greater than or equal to the second gap width S2. Particularly preferred are the first coil distance D1, as indicated in FIG. 1, greater than the first gap width S1 and the second coil distance D2 greater than the second gap width S2. Accordingly, the first and second partition walls 31, 32 each have a partition wall thickness, measured in the axial direction 91, which is at least equal to or, as shown, preferably greater than the gap width S1, S2 of the respective adjacent gap 61, 62. A ratio D1/S1 of the first coil distance D1 to the first gap width S1 can thus be greater than or equal to 1 and a ratio D2/S2 of the second coil distance D2 to the second gap width S2 can also be greater than or equal to 1. Particularly preferred are the two ratios D1/S1 and D2/S2 each greater than or equal to 1.1 or greater than or equal to 1.5 or greater than or equal to 2.

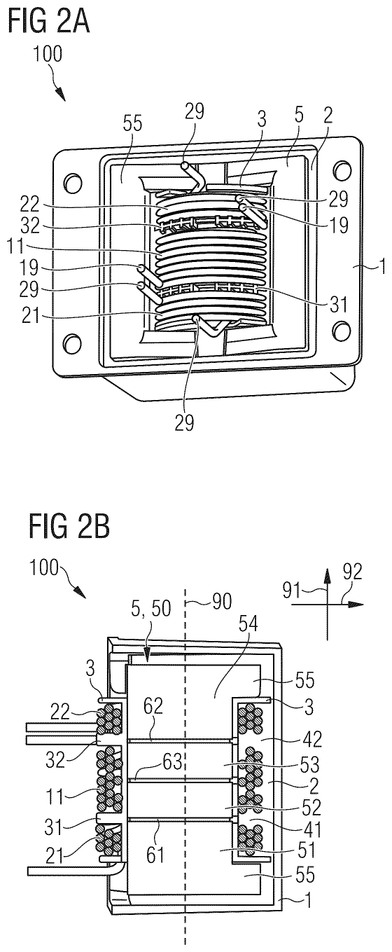

FIGS. 2A and 2B show a further embodiment of the transformer 100. Here, FIG. 2A shows a three-dimensional view of an assembly side of the transformer 100, while FIG. 2B shows a two-dimensional cut-away view of the transformer 100 with a sectional plane that extends along the axial direction 91 and is substantially perpendicular to the paper plane of the illustration shown in FIG. 2A. The coil axis 90 is indicated in FIG. 2B. The embodiment shown in FIGS. 2A and 2B is a modification of the embodiment shown in FIG. 1, so that the following description essentially refers to the differences to the embodiment of FIG. 1. Elements that are not provided with reference signs and/or that are not explained can be embodied as described in connection with FIG. 1.

The transformer 100 has a housing 1 which is configured like a cap and surrounds the other elements of the transformer 100 at least on the sides different from the mounting side. For this purpose, the coil carrier 3 with the primary coil 11, the first secondary coil unit 21 and the second secondary coil unit 22 and the magnetic core 5, which form a structural unit after assembly, are inserted into the housing 1. Spaces between the inserted components and the housing 1 can be filled with a plastic material 2, for example a non-ferromagnetic resin, and fix the inserted components in the housing 1. As can be seen in FIG. 2B, the plastic material 2 can form the partitions between the primary coil 11 and the first and second secondary coil units 21, 22, at least in partial areas, while in other partial areas parts of the coil carrier 3 form the partitions 31, 32.

In comparison with the embodiment shown in FIG. 1, each of the first and second secondary coil units 21, 22 has two terminals 29 for external contacting. In this case, the series connection of the first and second secondary coil units 21, 22 described in connection with FIG. 1 can be achieved by an external connection of one of the terminals 29 of the first secondary coil unit 21 and one of the terminals 29 of the second secondary coil unit 22. By way of example only, in this embodiment, the primary coil 11 has a winding number N1 of 17 and each of the secondary coil units 21, 22 has a winding number N2 of 9.

The first and second gaps 61, 62 are filled with a non-ferromagnetic material, which for example comprises or is made of a plastic and/or a ceramic material. The material filling the first and second gaps 61, 62 can in particular permanently connect two parts 51, 52 and 53, 54 of the central core portion 50 to each other. The magnetic core 5 can thus be formed from two units, each of which has two parts 51, 52 and 53, 54 of the central core portion 50. The two units are inserted into the primary coil 11 and the first or second secondary coil unit 21, 22 from opposite sides in the axial direction 91, wherein the central gap 63, which remains air-filled, is formed after complete insertion. The magnetic core 5 also has frame parts 55 which surround the central core portion 50.

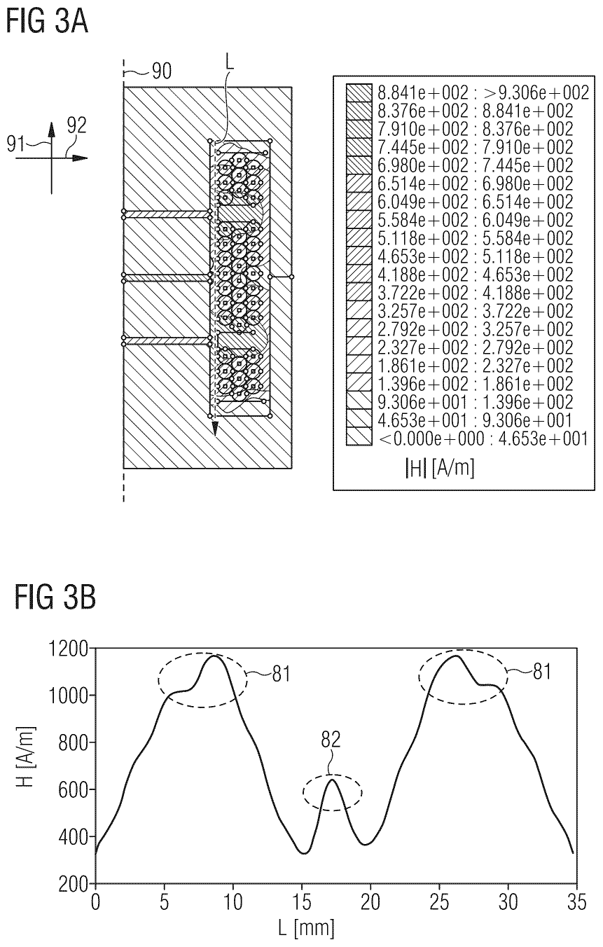

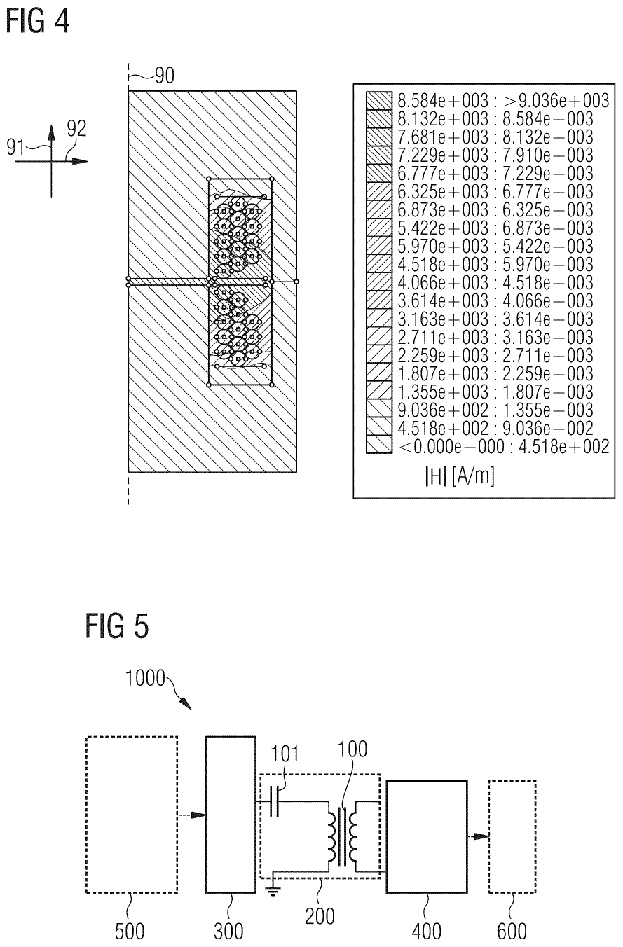

The transformer 100 according to the embodiments described in FIG. 1 and FIGS. 2A and 2B is characterized in particular by a three-chamber winding with thick partition walls 31, 32, i.e. large coil gaps 41, 42, which lie exactly over the two outer gaps, i.e. the first and second gaps 61, 62, of the magnetic core 5, which is a distributed-gap core. To illustrate the advantageous effects of this structure, FIGS. 3A and 3B show results of a simulation of the field distribution of the magnetic field H in a transformer according to the previous embodiments. FIG. 3A shows a density distribution of the magnetic field H, while the graph in FIG. 3B shows the field distribution along the axis L indicated in FIG. 3A and thus along the coil carrier. For comparison, FIG. 4 shows the results of a simulation of the field distribution of the magnetic field H in a conventional transformer with a two-chamber winding, in which there is only one air gap, below which the primary coil is arranged and above which the secondary coil is arranged, each of which has the same number of windings. In the simulation of the transformer 100 described here and the comparative example, the parameters and in particular the number of windings were selected so that the same main inductance and the same leakage inductance were achieved.

The leakage inductance can be adjusted using the described partition thicknesses and thus the described coil distances. The thicker the partition walls and thus the greater the coil distance, the further away the windings of the primary coil and the secondary coils are from the magnetic field emerging from the first and second gaps. This leads to a reduction in additional losses that can be caused by the time-varying magnetic fields. The greater distance between the coils or the large thickness of the partitions meets the requirement for a high leakage inductance.

Changing from a two-chamber structure to a three-chamber structure reduces the leakage inductance. However, this can be at least partially compensated for by increasing the number of windings in the primary coil. A higher number of windings in turn reduces the maximum magnetization flux density, which has a positive effect on the core losses.

The stray field is the part of the magnetic field that does not contribute to the main inductance. This part is added precisely in the area of the leakage channels or partitions. Due to the larger coil distance, i.e., the thick partition walls, the windings of the primary coil and the secondary coils are thus removed from the stray field. This leads to a further reduction in additional losses. FIG. 3B in particular clearly shows that the magnetic field strength in the area of the partitions (marked areas 81) is very high compared to the magnetic field strength in the area of the central gap (marked area 82).

Comparing FIG. 3A with FIG. 4, it is noticeable that the coil windings are exposed to a larger proportion of the magnetic field in the two-chamber design compared to the three-chamber design. However, this results in higher additional losses in the two-chamber winding compared to the three-chamber winding. A comparison using the same electrical and magnetic parameters results in a power loss of 41.4 W for the simulated three-chamber structure, while the two-chamber structure results in a power loss of 58.6 W.

In FIG. 5, a schematic circuit diagram shows an electrical device 1000, which may be a DC-DC converter, for example, comprising the transformer 100 according to the previous embodiments. In particular, the transformer 100 is part of a resonant element 200 of the electrical device, which is arranged between an inverter unit 300 and a rectifier unit 400. The inverter unit 300 may be connected to a DC power source 500, for example formed by an AC power source and a rectifier or a battery, as indicated in FIG. 5, while the rectifier unit 400 may be connected to a load 600, for example a battery to be charged. The direct current source 500 and the load 600 are not necessarily parts of the electrical device 1000.

The resonant element 200 can preferably be connected directly to the inverter unit 300 on its input side and directly to the rectifier unit 400 on its output side. The resonant element 200 can also be referred to as a “resonant tank”. The transformer 100 can preferably form the resonant element 200 together with at least one capacitor 101 or, as shown, exactly one capacitor 101. In particular, the resonant element 200 is free of further inductive components apart from the transformer 100. This means that, apart from the transformer 100, there is no further inductive component such as an inductor or choke between the output of the inverter element 300 and the input of the rectifier element 400, but only one or more capacitors and/or one or more resistors. The inductances required for the LLC configuration are formed by the magnetizing inductance and the leakage inductance of the transformer 100. This results in a simplified and compact structure. The previously described three-chamber structure of the transformer 100 means that losses can be kept to a minimum.

The features and embodiments described in connection with the figures can be combined with each other according to further embodiments, even if not all combinations are explicitly described. Furthermore, the embodiments described in connection with the figures may alternatively or additionally have further features as described in the general part.

The invention is not limited to the embodiments by the description based on the embodiments. Rather, the invention includes any new feature as well as any combination of features, which includes in particular any combination of features in the patent claims, even if this feature or this combination itself is not explicitly stated in the patent claims or embodiments.

1.-16. (canceled)

17. A transformer comprising:
a first secondary coil unit, a primary coil and a second secondary coil unit arranged in succession along an axial direction; and
a magnetic core comprising a central core portion, which is located in the primary coil, the first secondary coil unit and the second secondary coil unit so that the primary coil, the first secondary coil unit and the second secondary coil unit each surround the central core portion in a radial direction,
wherein the primary coil is arranged between the first secondary coil unit and the second secondary coil unit,
wherein a first coil gap defining a first coil distance along the axial direction is provided between the primary coil and the first secondary coil unit and a second coil gap defining a second coil distance along the axial direction is provided between the primary coil and the second secondary coil unit,
wherein the central core portion has a central gap arranged, along the axial direction, between a first gap and a second gap,
wherein the first gap and the first coil gap have an identical first position in the axial direction and the second gap and the second coil gap have an identical second position in the axial direction so that the first gap is surrounded in the radial direction by the first coil gap and the second gap is surrounded in the radial direction by the second coil gap, and
wherein the first coil distance is greater than or equal to a first gap width of the first gap in the axial direction and the second coil distance is greater than or equal to a second gap width of the second gap in the axial direction.

18. The transformer according to claim 17, wherein the first coil distance is greater than the first gap width and the second coil distance is greater than the second gap width.

19. The transformer according to claim 17, wherein a ratio of the first coil distance to the first gap width is greater than or equal to 1.1 and a ratio of the second coil distance to the second gap width is greater than or equal to 1.1.

20. The transformer according to claim 17, wherein the central gap is arranged symmetrically to the primary coil in the axial direction.

21. The transformer according to claim 17, wherein the first gap and the second gap are arranged symmetrically to the central gap along the axial direction.

22. The transformer according to claim 17, wherein the first and second gaps are of equal size.

23. The transformer according to claim 17, wherein the central gap is larger than the first gap and larger than the second gap.

24. The transformer according to claim 17, wherein the central gap has a gap width in the axial direction of greater than or equal to 0.5 mm and less than or equal to 2 mm.

25. The transformer according to claim 17, wherein the central gap is air-filled.

26. The transformer according to claim 17, wherein the first and second gaps are filled with a non-ferromagnetic material comprising a plastic and/or a ceramic material.

27. The transformer according to claim 17, wherein the first coil distance and the second coil distance are equal.

28. The transformer according to claim 17, wherein a first partition wall is arranged between the primary coil and the first secondary coil unit and a second partition wall is arranged between the primary coil and the second secondary coil unit, which are each part of a coil carrier.

29. The transformer according to claim 17, wherein the primary coil has a winding number N1 and the first and second secondary coil units each have a winding number N2, wherein N1>N2 applies.

30. The transformer according to claim 29, wherein 1.2≤N1/N2≤4 applies.

31. The transformer according to claim 17, wherein the first and second secondary coil units are connected in series.

32. An electrical device comprising the transformer according to claim 17;
an inverter unit; and
a rectifier unit,
wherein the transformer together with at least one capacitor forms a resonance element between the inverter unit and the rectifier unit, and
wherein the resonant element is free of further induction components.
